(19) United States
(12) Patent Application Publication
(10) Pub. No.: US 2009/0147962 A1
(43) Pub. Date: Jun. 11, 2009

(54) CONSUMER ELECTRONICS DEVICE WITH HEADPHONES

(75) Inventors: Ulrich Sieben, Vorstetten (DE); Miodrag Temerinac, Gundelfingen (DE)

Correspondence Address: DUANE MORRIS LLP - Princeton, PO BOX 5203, PRINCETON, NJ, 08543-5203, US

(73) Assignee: MICRONAS GMBH, Freiburg (DE)

(21) Appl. No.: 12/265,875

(22) Filed: Nov. 6, 2008

(30) Foreign Application Priority Data
Nov. 6, 2007 (DE) 10 2007 053 188.7

(51) Int. Cl. H04R 29/00

(52) U.S. Cl. 381/58

(57) ABSTRACT

A system having a consumer electronics device (1) providing an audio signal (21), a device (3) for the setting of, particularly a frequency response and/or a set of dynamics of the audio signal (21), and at least one set of headphones (5) for playing back the audio signal (21), wherein a device (7) for determining an individual hearing characteristic, such as a hearing threshold level of a user, is provided, by means of which particularly the frequency response and/or the dynamics of the audio signal (21) can be adjusted according to the determined hearing characteristic of the user.

The invention relates to a system having a consumer electronics device according to the generic characteristics of patent claim 1.

Various methods are known from medical audiology in order to determine the individual hearing ability, particularly the hearing threshold level of a person. In simple methods a sound is played for a person, and is asked, if he/she can hear the same or not. If this process is repeated using different sound frequencies and volumes, an image of the hearing ability of the respective person is formed, the so-called hearing threshold level. This hearing threshold level is utilized, for example, in order to adjust the amplifying properties of a hearing aid in various frequency ranges in order to compensate a dysfunction of the hearing ability of the respective person.

Further methods known for determining of the hearing threshold level of a person are so-called interval methods, which are characterized by a low ability of manipulation of the method by the test person. In the two-alternative-forced-choice (2AFC) method, for example, an acoustic stimulation is provided to a test person in one of two successive time intervals, upon which the test person must select by operating a switch, in which time interval he/she has heard the sound. For this purpose, the time intervals are, for example, optically signalized. Once the signals are provided at various volumes and frequencies, the hearing threshold level of a person can be determined by means of a statistical analysis of the person's responses. Due to the increased amount of devices needed, however, this method is not very common in practice, and is therefore utilized only in scientific test applications.

Furthermore, headphones are generally known, which have a high amplification specifically for hearing impaired persons. However, a disadvantage of such headphones is that an audio signal has this high amplification in all frequency bands without being adjusted to the specific hearing impairment of the user. A compensation of hearing impairments in certain frequency ranges is therefore not possible.

A television device is known from JP 2003 230071 A, wherein an adjustment of the volume and/or frequency of the audio output of a television device is carried out based on the results of an audiometric test. One problem is that the audio playback of this television device is adjusted to only one person, and such an audiometric test can only be performed by a physician, or in a hospital. The device described in JP 2003 230071 A is therefore not suited to provide an optimal sound for multiple persons.

It is the object of the invention to further improve a system having the generic characteristics of patent claim 1 such that an optimal sound result can be simultaneously provided for multiple persons without requiring a visit to the audiologist.

This object is solved by means of a system having the characteristics of claim 1.

Advantageous embodiments and further improvements of the invention are the subject of the sub-claims.

In the simplest of cases, a system according to the invention comprises a consumer electronics device, for example, a television device, providing an audio signal, a device for adjusting the audio signal, particularly the frequency response and/or the dynamics of the audio signal thereof, and at least one set of headphones for playing back the audio signal. Furthermore, a device for determining an individual hearing characteristic, such as the hearing threshold level of a user, is provided, by means of which, for example, the frequency response and/or the dynamics of the audio signal can be adjusted according to the hearing characteristic determined.

The system according to the invention is therefore capable, for example, of determining the hearing threshold level of a user, and balance any deficits in individual frequency bands of the audio signal accordingly. These deficits, however, do not necessarily have to be due to a hearing dysfunction, but can also result from, for example, a frequency response of the headphones, or of a transmission channel between the consumer electronics device and the headphones.

The device for determining the hearing characteristic of the user can optionally be positioned in the headphones, or in the consumer electronics device. Purposefully, the device will be arranged within the consumer electronics device for better space accommodation. It is also possible that the audio signal of a consumer electronics device is tapped via a headphone output, and guided to a further device carrying out the transmission of the audiogram and the adjustment of the frequency response. Such a device can then be connected, for example, to a regular television device such that an audio signal adjusted to the individual hearing threshold level of the user is available on the output side.

Preferably, the system is configured such that a memory device for storing the hearing characteristics of various users, or for different sound profiles, is provided.

According to a further improvement of the invention a switching device is provided for selection by the user. This switching device may be configured, for example, as a simple switch on the headphones, as a fingerprint sensor, or as an integrated switching device, being switchable via a code input, such as via remote control.

Further, it is also possible that the headphones have a unique identification, thus enabling a unique association of a hearing threshold level, or of an audio profile, respectively, to a set of headphones, and the user thereof. It is also possible, for example, to simultaneously supply multiple headphones with individually adjusted audio signals by means of a consumer electronics device such that an optimal sound result is provided for a plurality of persons.

According to a second embodiment of the invention a device is provided for compensating background noises. Such devices are generally known and enable the further amplification of the provided audio signal accordingly in case of background noises, thus ensuring comprehension.

Preferably the system is configured such that the determination of the audiogram is carried out according to the two-alternative-forced-choice (2AFC) method, wherein the time intervals necessary for the method are optically signalized. This method is particularly suited in association with a television device, since an introduction into the measurement procedure and the signaling of the measurement intervals are possible via the screen of the television device.

The invention is further described in detail based on the attached figures. The same reference symbols always denote the same or functionally equal components. They show:

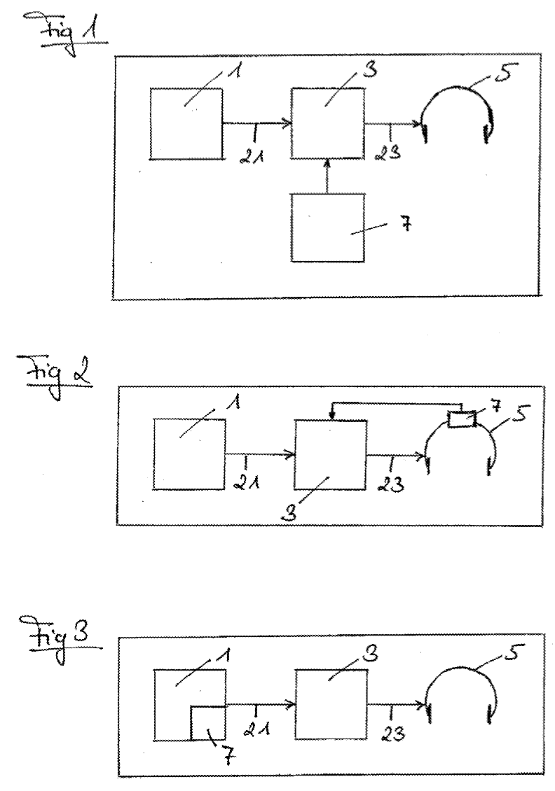

FIG. 1 a block diagram of a system according to the invention,

FIG. 2 the block diagram of FIG. 1, wherein the device for determining the hearing threshold level is arranged within the headphones,

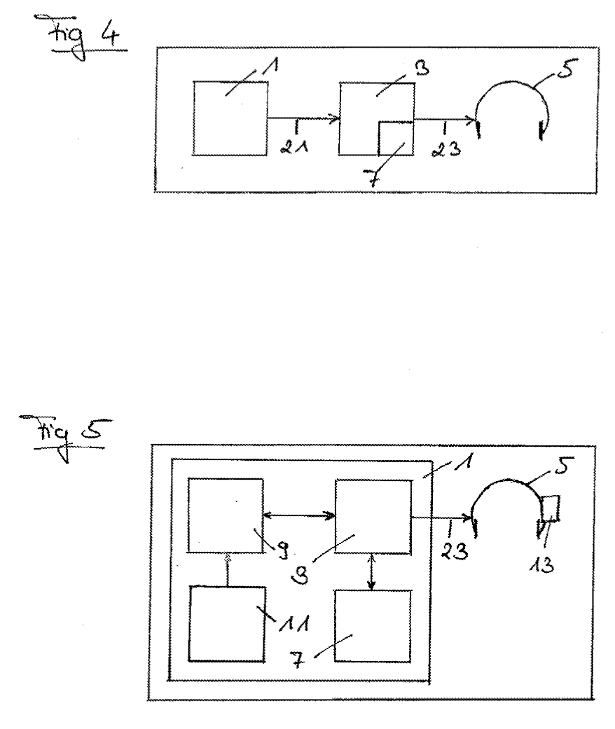

FIG. 3 the block diagram of FIG. 1, wherein the device for determining the hearing threshold level is arranged within the consumer electronics device,

FIG. 4 the block diagram of FIG. 1, wherein the device for determining the hearing threshold level is arranged within the device for adjusting the frequency response,

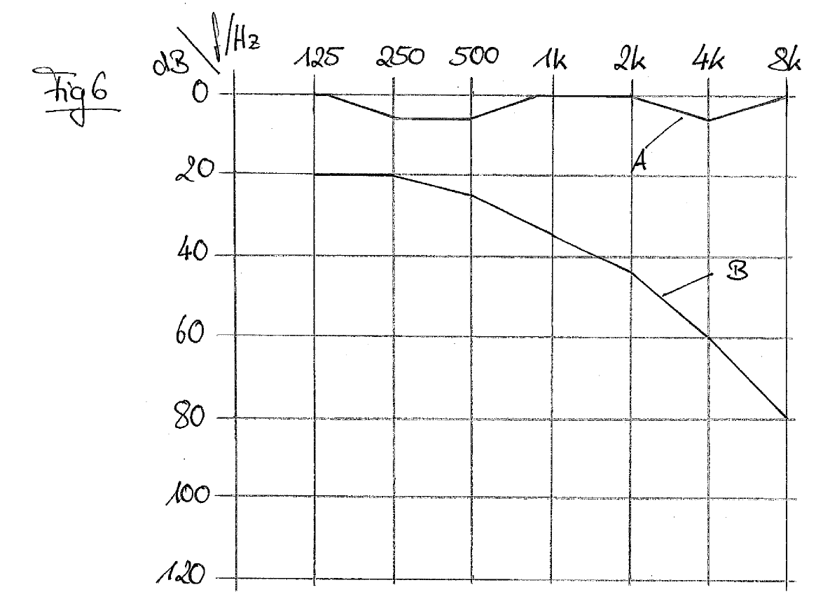

FIG. 5 a block diagram of a further embodiment of the system according to the invention, and

FIG. 6 exemplary gradients of hearing threshold levels of a healthy human, and of a human suffering from a medium-severe sensorineural high-pitch hearing loss.

FIG. 1 illustrates a system having a consumer electronics device 1, providing an audio signal 21, which is supplied to a device 3 for adjusting a frequency response, a so-called equalizer. The equalizer provides an audio signal 23 at the output thereof, which is modified according to the settings of the equalizer 3, which can be supplied to headphones 5, particularly wireless headphones (such as via a Bluetooth connection). The adjustment of the equalizer 3 is carried out according to a hearing threshold level of a user, which has been determined by means of a device 7.

As illustrated in FIG. 2, the device 7 for determining the hearing threshold level of the user may be arranged within the headphones 5. In this case, as illustrated in FIG. 2, a bidirectional connection is necessary between the headphones 5 and the equalizer 3 such that the frequency response of the audio signal 21 can be adjusted by the equalizer 3 according to the hearing threshold level determined.

FIG. 3 illustrates the components of FIG. 1, wherein the device 7 for determining the hearing threshold level of the user is arranged within the consumer electronics device 1.

As illustrated I FIG. 4, it is possible that the device 7 for determining the hearing threshold level of the user is positioned in the device 3 for adjusting the frequency response of the audio signal 21. In this configuration it is possible that the device 3 for adjusting the frequency response and the device 7 for determining the hearing threshold level form a separate device, which may be connected to existing consumer electronic devices 1.

As illustrated in FIG. 5, it is also possible that both the equalizer 3 and the device 7 for determining the hearing threshold level of the user are arranged within the consumer electronics device 1. FIG. 5 further illustrates a memory unit 9, which enables that the hearing threshold levels of different users can be stored. According to a switching device 11, the respective hearing threshold level profile is then accessed, and the frequency response is adjusted in the equalizer 3 accordingly, and provided to the user. In this embodiment a device 13 for the compensation of background noises is further arranged on the headphones 5, which, for example, detects any interfering ambient noises by means of a microphone, and balances the same accordingly such that no interferences occur. The device 13 may also be positioned within the consumer electronics device.

The arrangements described in FIGS. 1 to 5 are not limited to the use of one single set of headphones 5. If an accordingly higher number of equalizers 3 is provided, it is possible to provide an optimally adjusted audio signal 23 to multiple users via one set of headphones 5 each.

FIG. 6 illustrates an audiogram, as can be recorded using a system according to the invention. In such an audiogram the frequency dependant hearing of a person can be illustrated graphically. The gradient denoted by A shows the course of the hearing threshold value, as it is recorded of a healthy human. Gradient B shows the hearing threshold level of a human suffering from medium-severe sensorineural high-pitch hearing loss. As is obvious from FIG. 6, the hearing of a human suffering from such a hearing impairment is reduced relatively drastically in a high frequency range. For this purpose, a system according to the invention enables the compensation of the hearing loss obvious from the audiogram and provides an amplified audio signal in the respective frequency responses such that nearly the sound result of a healthy human can be obtained.

The function of the system according to the invention is explained as follows.

In a first step for starting the operation of the system illustrated in FIG. 5, the user must identify himself/herself as a certain user by means of switching on the switching device 11 before determining the hearing threshold level. Subsequently, the hearing threshold level of the user is determined according to the 2AFC method. For this purpose the user is shown a brief introduction into the measuring method on the screen of the television device, and subsequently a respective measurement is carried out. During the course of the measurement the gradient of a medium-severe sensorineural high-pitch hearing loss, illustrated, for example, in FIG. 6 under item B, may be shown. The determined gradient of the hearing threshold level is then compared to the stored gradient of the hearing threshold level of a healthy human, as illustrated in gradient A of FIG. 6. For playback, the equalizer 3 is adjusted such that compensation of the determined hearing threshold level is achieved by means of amplification in the respective frequency responses. Both the determined hearing threshold level and the settings of the equalizer 3 determined by means of comparison are stored in the memory 11. If the same user desires to utilize the system again at a later time, re-entering an identification suffices in order to access the stored adjustment and to obtain a matching compensating audio signal.

If the system according to the invention is operated using multiple sets of headphones, it is possible to either firmly associate the stored user settings with one set of headphones 5, or to equip the headphones 5 with respective switch over devices 11 for selection by the user such that multiple users may receive an audio signal 23 adjusted to the different settings.

Although a television device has been introduced in the exemplary embodiment as the consumer electronics device, the invention is not limited to the same. An MP3 player, a CD player, a personal computer, a cellular phone, or similar could also be utilized.

Such a device merely has to comprise the components described above. In order to carry out the 2AFC method, an optical display for signalizing the measurement intervals is also necessary, wherein the devices stated as examples all comprise respectively configured displays.

Purposefully, all signal processing tasks are carried out within the consumer electronics device, because high-performance signal processors are already present in the same, by means of which the determination of the individual hearing characteristics of the user is easily possible, as well as the influencing of the audio signal depending thereupon, wherein the audio signal is to be output to the headphones. The audio signal processed and prepared for each individual user within the consumer electronics device in this manner is preferably transmitted to the headphones in a digital manner, such as via Bluetooth technology.

### LIST OF REFERENCE SYMBOLS

1 consumer electronics device
3 device for adjusting the frequency response/equalizer
5 headphones
7 device for determining the hearing threshold level
9 memory device
11 switching device
21 audio signal
23 modified audio signal
A hearing threshold level of a healthy human
B hearing threshold level of a human suffering from medium-severe sensorineural high-pitch hearing loss

1. (canceled)

2. The system according to claim 16, wherein the device for determining the hearing characteristic is arranged within the headphones.

3. The system according to claim 16, wherein the device for determining the hearing characteristic is arranged within the consumer electronics device.

4. The system according to claim 16, further comprising a memory device for storing different hearing characteristics of different users.

5. The system according to claim 16, further comprising a switching device for selection by the user.

6. The system according to claim 16, wherein the headphones comprise a unique identification.

7. The system according to claim 16, further comprising a device for compensating background noises.

8. The system according to claim 16, wherein the consumer electronics device is a television device.

9. The system according to claim 16, wherein at least one frequency response and/or one set of dynamics of the audio signal can be adjusted according to the hearing characteristic determined.

10. The system according to claim 16, wherein the device for determining an individual hearing characteristic of a user is a device for determining the hearing threshold level of this user.

11. The system according to claim 16, wherein a left and a right channel of the audio signal can be adjusted independently of each other according to the hearing characteristic determined.

12. The system according to claim 16, wherein the headphones are coupled to the consumer electronics device in a wireless manner.

13. The system according to claim 16, wherein a transmission of an audio signal to be output at the headphones is carried out from the consumer electronics device to the headphones in a digital manner.

14-15. (canceled)

16. A system comprising:
a consumer electronics device providing an audio signal;
a device for adjusting the audio signal;
at least one set of headphones for playing back the audio signal; and
a device for determining an individual hearing characteristic of a user by means of which the audio signal can be adjusted according to the hearing characteristic determined.

17. The system according to claim 12, wherein the wireless manner comprises a Bluetooth connection.

18. A method for determining a hearing threshold level, the method comprising the steps of:
providing a system comprising a consumer electronics device providing an audio signal, a device for adjusting the audio signal, at least one set of headphones for playing back the audio signal, and a device for determining an individual hearing characteristic of a user by means of which the audio signal can be adjusted according to the hearing characteristic determined; and
performing a two-alternative-forced-choice method with the system.

19. The method according to claim 18, wherein the consumer electronics device signalizes time intervals when performing the two-alternative-forced-choice method.
